(19) United States
(12) Patent Application Publication
(10) Pub. No.: US 2013/0103429 A1
(43) Pub. Date: Apr. 25, 2013

(54) Method and System for creating a report comprising of a generated score directly associated to individual drivers Mobile Technology Use During Road Travel (MTUDRT).

(71) Applicant: Edwin Buitrago, Plainville, CT (US)

(72) Inventor: Edwin Buitrago, Plainville, CT (US)

(21) Appl. No.: 13/623,887

(22) Filed: Sep. 21, 2012

Related U.S. Application Data
(60) Provisional application No. 61/626,334, filed on Sep. 23, 2011.

(51) Int. Cl. G06Q 40/08

(52) U.S. Cl. CPC G06Q 40/08
USPC 705/4

(57) ABSTRACT

A method of gathering data of actions/interactions associated to the use of Multi-function Mobile Communication Devices (MMCD), mostly devices known as Smartphones. Through the use of software application, mobile use determination data is collected and utilized into an algorithm for the creation of a score then reflected on a Driver Accountability Report (DAR). This report provides an assessment of the propensity of Mobile Technology Use (MTU) associated to individual drivers via a rating in the form of a score and visualizations which may be used as a gauge of distracted driving levels as it relates to Mobile Technology Use During Road Travel (MTUDRT).

### FIELD OF INVENTION

This invention provides insight about a driver's MTUDRT for interested third parties such as insurance carriers, corporate fleets, employers, parents, and drivers themselves. This invention provides the ability to assess risk through propensity of MTUDRT in the form of a report inclusive of a score and star rating system. Said report can be used as a Driver Accountability Report (DAR) to enable insurance carriers the assessment of, (i) value of auto insurance policies (ii), adequately risk pricing premiums according to individual's driver behavior, (iii) risk management of insurance coverage to insurance providers and other institutions holding to the report's score and inherent merit, (iv) behavior of drivers during roadway travel.

The implementation of the said invention generally works in the following manner: A consumer submits an auto insurance application. Upon receipt of such an application, regardless of the form of application whether paper, digitally, or electronically, the agent must determine the adequate premium rate to appropriately fund a proposed insurance policy to cover the associated insurance policy's fees, potential consumer credits, and profitability of any proposed insurance. The risk assessing process of the application is necessary to determine the level and layers of risk per applicant. The insurance agent handling the process of risk assessment would run the consumer's data through the subject invention, a behavioral scoring model, which scores the applicant's propensity of MTU during road travel. Having such a report and scoring system available, allows automobile insurance carriers and other interested parties to utilize such data to make better informed decisions regarding consumers as it relates to MTUDRT.

### BACKGROUND OF THE INVENTION

With an increasing number of accidents due to distracted driving from mobile technology usage (MTU), the number of permanent injuries and loss of human life has also increased. Despite hands-free legislation in many states, the inconsistent enforcement and ensuing minimal consequences have provided insufficient deterrents for overconfident drivers to end irresponsible behavior. Texting, messaging, and emails are almost tantamount to phone calls as primary modes of communication. Beyond a conscientious concern for road safety and a fear of misdemeanor fines, there is no accountability and neither external nor inherent incentives for drivers to change behavior and isolate MTU apart from driving.

Where automobile insurance companies currently measure risk associated with an individual applicant by, (i) motor vehicle record, (ii) credit check, (iii) prior claims report; such third party data does not measure the risk of MTUDRT which results in distracted driving as national statistics reflect as the major cause of many Distract Driving Related Accidents (DDRA).

In the process of initiating a new automobile insurance policy, the industry as a whole refers to the applicant's demographics and said third party reports in order to adequately measure the level of risk associated with the individual applicant seeking automobile insurance coverage. This is done in order to appropriately rate and price the policy per individual in upholding the value of such insurance policy.

It's evident in the protocol described above that one major area of risk is being lost in the assessment process. That area is in the relation between automobile accidents and the use of mobile technology while on roadways. This in turn is costing insurance providers in the form of paid out claims and the processing thereof. The current use of overall averages from statistics of DDRA's results in additional premium expenses to all potential insured's as a whole versus individualizing that risk according to the behavior of the individual insured.

Therefore the auto insurance industry could benefit greatly from the ability to better assess the individual risk of MTUDRT in advance of offering a specified premium for auto insurance in order to either reward a driver in the form of a discount for safe handling of a personal mobile device during roadway travel or to adequately price the policy by the predetermined risk level therein sustaining the policy's integrity of value.

In recognition of the potential impact of a national scoring standard for MTUDRT the ability to score an individual driver's MTU also helps induce behavioral changes that reduce distracted driving caused by MTU. In turn, it is foreseeable that this reform of societal expectations, now quantified by this invention's report and score, saves lives, reduces the number of injuries, as well as the cost of automobile insurance claims, health insurance claims, and cost of municipal first responder services. The scoring from this invention is beneficial to all roadway travelers nationwide.

Based on current knowledge, any prior art for such a score, rating system, and report from data pertaining to an individual driver's MTUDRT is nonexistent.

Having access to an MTU propensity scoring system greatly improves the insurance carrier's risk assessment. This novel insight adds value to the marketing, underwriting, administrative process, and issuance of policies/licenses similar to, and ideally for, the automobile industry. Informed with such a scoring report, one of the many areas the insurance industry can benefit is to; eliminate excessive losses created by the growing trend of costly DDRA claims due to inappropriate MTU. In turn, reduce losses may help hedge against increasing costs for automobile insurance coverage.

To the insured, this system offers a variety of potential advantages. Likely to reduce individual policy premiums based on the individual's score. The accountability and monetary benefits encourage behavioral changes that focus on roadway safety for all drivers, their passengers, and all fellow roadway travelers. Drivers may grow to develop safer driving habits and find value in earning a good score in hopes of a good report and help make their insurance coverage more affordable.

The specific issue, of an individual's behavior towards high MTU and the inadequate risk assessment thereof creates a void in the overall assessment of individuals applying for automobile insurance coverage. The proposed scoring module addresses the relation between insurance carrier's financial risk and financial reward by filling the said void. Therefore, through the implementation of said invention, insurance carrier's may greater individualized rating tables to improve their bottom line and create overall stability to automobile insurance costs.

The said invention enables insurance companies to measure the level of risk associated with a driver's MTU. This report and its encompassing score is the first and presumably only third party data directly related to DDRA from mobile technology use specific to the individual driver. This additional and crucial information implies reduced risk to all automobile insurance carriers and an accountability tool for drivers.

### BRIEF SUMMARY OF INVENTION

The invention described herein is a method and system for determining a score and creating a Driver Accountability Report (DAR) directly associated to an individual's mobile technology usage during roadway travel (MTUDRT) through a developed rating system incorporating captured data from mobile devices.

The invention encompasses at least a mobile software application (App) which can be downloaded to a smartphone phone electronically or wirelessly and/or hardcoded computer programming (HCP) within the manufactured smartphones and/or any future Multi-function Mobile Communication Device (MMCD) by any other name that will function in equal operations. The App or HCP will operate as a fully disclosed and consensual data capture/retrieval motion detection system that will transmit secured and encrypted information via electronically and/or wireless channels of specific MTUDRT.

The subject invention anticipates reception of DAR inquiries via the internet or other digital/electronic means such as wireless communications/other methods. It is also anticipated that the DAR Report system would be corporately implemented within insurance carriers application portals without limitation to the DAR application or DAR retrieval means, be it spoken, written, automated digitally, electronically, or type-processed via paper applications.

Upon a consumer party submitting an application for automobile insurance the agent would include the DAR report as part of their risk grade assessment process in order to adequately price the insurance policy to be offered. Within the subject invention, the process to submit a request for a DAR report by the insurance agent/interested party requires submission of the applicant's specific identification information to Cinqpoint, LLC, as it will serve the insurance carriers or interested parties as the invention developer, manager, data processor, DAR reporter and objective third party scoring representative. The application data is processed through the subject invention's databanks to identify the individual as a specific App/HCP user, retrieve their most current information, apply information to the mathematical scoring model, aggregate and prepare data/scores/ranks to produce and present a DAR score/report which would then be delivered to the agent via the same method of submission in which the application data was received.

### BRIEF DESCRIPTION OF THE DRAWINGS

FIG. 1 is a block diagram showing the preliminary system of the present invention.

FIG. 2 is an overview of the primary process of the present invention.

FIG. 3 is a block diagram overview of the present invention.

### DETAILED DESCRIPTION OF THE PREFERRED EMBODIMENT OF INVENTION

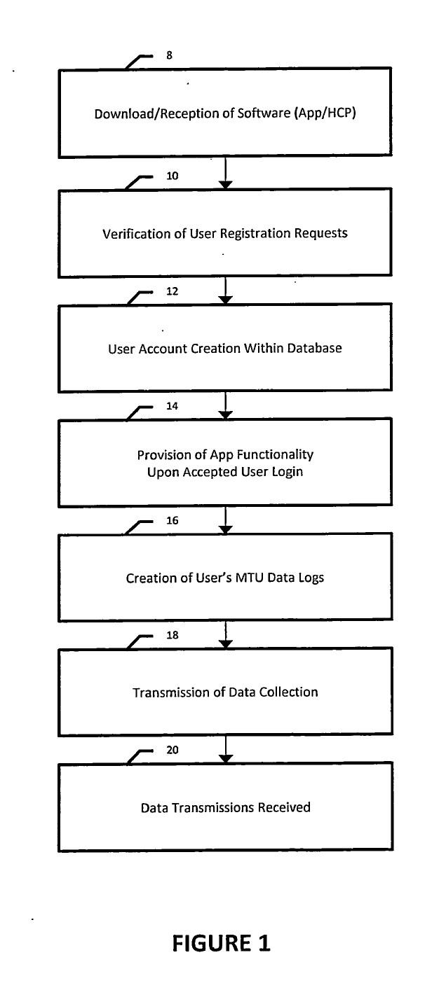

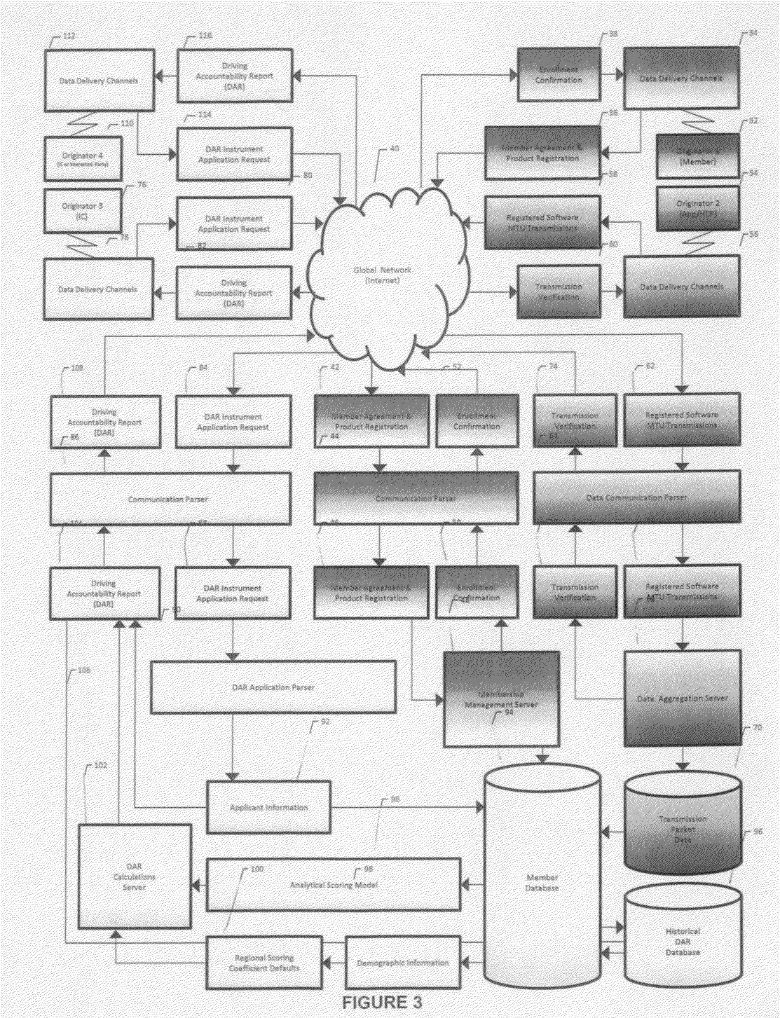

Referring to FIG. 1, an overview of the preliminary system of the present invention is shown. The mobile technology executable software (App) shall be downloaded and installed from available marketplace App stores (8). In further view, firmware embodiments in hardcoded computer programming (HCP) may be provided on mobile technology operating systems. Complete App accessibility and use is granted with registration described below. Individual users register (10), providing unique identification information. The present invention anticipates registrations over the internet(FIG. 3, 40). User registration provides necessary permissions to collect actions of MTU and MTUDRT. Upon the accepted user registration, individual user accounts are created (12) within the user account database (UAD). Upon the initial login, and/or subsequent login(s), of a verified user, functionality of the App/HCP data collection capabilities begin along with other GUI features (14). Under pertinent user agreements, user shall allow MTU data collection (16) from mobile device software and the transfer of created data logs (18) to invention servers via communication channels, primarily wireless internet transmission. The present invention anticipates this data traffic which enters the communications parser (FIG. 3, 64) and is designated to appropriate user account storage databases (FIG. 3, 20).

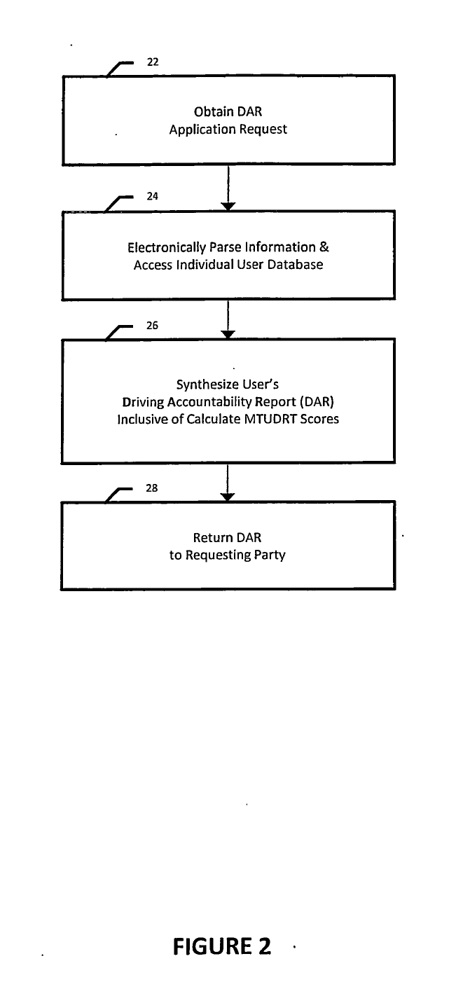

Referring to FIG. 2, an overview of the primary process of the present invention shown. After individual users register App/HCP and agree to the data collection process via mobile technology communications (FIG. 1), interested and authorized parties/consumers obtain identification information and complete a DAR application request (22) for a specific User. That information is electronically transmitted to the present invention, which anticipates these requests and parses the user information (24) in the DAR application into various categories relevant to the scoring system and creation of the DAR analysis. The DAR application request contents allow the database to identify a specific user account then, jointly provide the informational needs of the mathematical scoring model to calculate the MTUDRT score (26) and particular action propensities about the user MTU that reside in the present invention. A DAR analysis is synthesized (26) for the inquiring party/consumer as a function of the particular user's MTU data (FIG. 1, 18) by combining user's historic and current: MTUDRT scores, particular action propensities, and other descriptive analytics with visualizations. The DAR, its MTUDRT score and other reported tendencies are returned to the requesting party/consumer (28). Thereafter, the interested parties can, based on the data provided in the DAR analysis of this invention, make more knowledgeable decisions regarding the user.

Referring to FIG. 3, the present invention overview, a said user has become an invention account holder (32) in so much as they have completed registration/user (36) and received registration confirmation (38) through appropriate data delivery channels (34). User agreements and product registrations (42) are anticipated by the present invention's communication server (44) and parsed (46) as such into the user account management server (48). Upon availability of a unique and new user account correlating to the request (36, database resources are allocated (94), the user account is created and registration verification (50 52) is returned to the originating party (32) via the internet (40) and initial delivery channels (34).

Said invention user(s) use and continue to utilize registered software (App/HCP) (54), allowing the creation/transmission (56) of gathered data regarding personal MTU and MTUDRT (58). The created log file of the App/HCP has a custom and definitive form, requiring specific validation through its unique construction parameters and defined layout. Data transmissions (62) are anticipated and received by the data communication parser (64). All recognized data files proceed to the data aggregation server (68) which verifies the appropriate user account and upon which, sends verification (72 74) through data channels. This verification confirms file delivery to either prompt the resending of the file or simply reopen anticipatory status. The Data server parses the data into categories based on captured action type (70). The data is to be allocated to the specified user account in the user account database (94). The microdata elements of the data file categories are inclusive of, but not limited to: phone calls, texting (SMS), keystrokes/screen interaction, instances of messaging, emailing, social media update posts, internet browsing, other internet use, other mobile application use, and the associated positional data, timestamps, duration, count, and file size where these descriptions are appropriate. The invention data server will unpack, aggregate, assign, and log this necessary data captured through the App/HCP. The numeric representation of this quantified data is specifically used to ascertain the calculated MTUDRT score within the analytical scoring model as part of this current invention (96).

Interested parties (76), for instance, insurance companies (110) receive authorization and submit DAR application request(s) (80 114) regarding a particular user(s). The identification information received by an Insurance Company (IC) or Interested Party for a user within the invention is input into the DAR request originator's data delivery channels (78). Such data channels (78) are (without limitation) paper, fax, email, Internet, and generally other electronic means. DAR Accountability Reports are returned (82) to the originating IC. Other ICs and interested parties (110) send DAR requests (114) regarding their respective applicants over their own data delivery channels (112) and receive DAR Accountability Reports (116).

The present invention anticipates reception of DAR request applications (84) over the internet (40) primarily. These DAR requests (88) enter the system of the present invention through a communication server (86). The applicant information concerning a given user is then processed within the application parser. Application parser (90) divides the information into nominal applicant information and applicant information specific to identifying the user within the invention UAD as a specific user account (92). This information includes, but is not limited to; first and last name, address, DOB, social security number, driver's license number and specific state issuer, and other demographic information concerning the applicant. For titling and identification purposes, the applicant information will be included in the final DAR analysis (104).

The User Account Database is supplied with this applicant information (92) to gather specific user data required for the DAR creation. The MTU scoring model (96) uses the elemental counts of actions and their descriptive labels to pre-score parsed data logs.

Demographic information (98) is used to incorporate specific preset coefficients used in the calculations (100). A calculations server (102) combines elements of the scoring module into: the MTUDRT scores for the last 6 months, the MTUDRT for the overall user history up to 5 years, the gauged propensity of captured MTU action data types for said time periods, and trending MTUDRT Score scatter plot points over time. The final DAR analysis is then prepared (104) including visualization elements of line graphs, sliding scales, star depictions, etc. Elements of the final DAR, including the recent MTUDRT score is recorded (106) into the historical database (96) for calculating one's overall historic MTUDRT. The completed DAR (108) is delivered to originating requestor via communication channels similar to that of the initial request.

The mathematical model for the present invention provides a structure to the collected MTUDRT activity. Instances of motion consistent with roadway travel are determined by comparing changes in positional data, GPS or other, above an artificial threshold of 10 miles per hour. The action data during these data motion instances (DI) and transmits these logs at least as often as daily. These instances are pre-scored for user actions within the log file, comparing/weighting an action's distractibility in terms of quantity, duration, and size. The specific embodiments of the DI pre-scores of the present invention are conceptually shown below, where BDI denotes the DI pre-score:

$${B}_{DI} \{ \begin{matrix}( {B}_{TS} + a ) ; & Any DI with {A}_{0} and T \leq 5 \\ ( {\%}_{{B}_{ts}} + b ) ( c + ln ( \sqrt{T} ) ) ; & Any DI with {A}_{0} and T \geq 5 \\ ( {B}_{TS} - [ {k}_{nar} ] [ {B}_{nar} ] + [ {k}_{sms} ] [ {B}_{sms} ] ) ; & Any DI with A = \sum SMS > 0\end{matrix} \}$$

Wherein, the variables Bts represent the user's base

App/HCP rating, the associated % bts accompanying BDI greater than 5 minutes as a percentage of said BTS, T representative of motion duration, the constants a, b, and c, suggestive of a defined a, b equal to one fifth of a, and c, the natural log functions vertical shift, approximately 1.5. These constants not arbitrary, but providing adjustability to the range of calculated pre-scores. Also, wherein, when A does not equal zero user actions during motion, kₙₐᵣ, Bₙₐᵣ, kₛₘₛ, Bₛₘₛ, and Bₜₛ are explained herein:

$${k}_{sms} = \{ \begin{matrix}[ {k}_{m ax} + p - ( {( d )}^{2} / 9 ) ] ; & for 0 \leq d \leq l \\ [ kmax - ( {t}_{f} / 6 ) + ( t / 8 ) ] ; & for d \geq l when t \leq {t}_{f} \\ {k}_{m ax} ; & for d \geq l when t \geq {t}_{f}\end{matrix} \}$$

$${k}_{nar} = \{ \begin{matrix}r - {k}_{sms} ; & for 0 \leq d \leq l \\ [ ( r + t ) / 6 ) ] ; & for d \geq l when t \leq {t}_{f} \\ {k}_{m i n} ; & for d \geq l when t \geq {t}_{f}\end{matrix} \}$$

In the simplest form of the calculations, the BDI pre-score is a BTS increased by kₛₘₛ and decreased by kₙₐᵣ, wherein the variables kₘₐₓ is an artificial constraint placed on the desired maximum increase and likewise, kₘᵢₙ is the constraint of the rating system's maximum decrement.

In the initial inception of the scoring module, kₘₐₓ and kₘᵢₙ are close to 300, and a population of users average Bts ratings close to 450, that employed for the initial grace period. The resulting scale therefore is a BDI pre-score for each sustained instance of motion between 150 and 750. The determined constant r is the desired range of scores. The determined constant t_{f} is the decided motion instance duration upon which the kₘᵢₙ and kₘₐₓ reach capacity. Any desired BDI output range is attainable given that {(Bₜₛ−kₙₐᵣ)≦B_{DI}≦(Bₜₛ+kₛₘₛ)}. The variable d is the number of days since user account creation, p is a determined grace period bonus, and 1 the number of days of the new user grace period which allows for adaptation and learning curve associated to App/Hcp usage.

Bₙₐᵣ and Bₛₘₛ are the scalar percentages applied to the user's earned kₙₐᵣ and kₛₘₛ respectively. Initiating MTUDRT of outgoing data is weighted slightly more heavily in Bₙₐᵣ than responding to mobile technology/app messages. Ignoring mobile technology alerts improve Bₛₘₛ, but any autoresponding features of mobile technology such as texting autoresponders, out of office email rules, and away messages are granted premiums. MTU retrieval of texts, emails, messages, web-browsing and other reading done DRT is prorated at a higher percentage as compared to when such actions take place in between instances of motion. Generally, these percentages are calculated as:

$${B}_{sms} = \frac{\sum {A}_{sms}}{\sum A} , where {A}_{sms} = ( \frac{( {AR}^{+} ) + 0.2 * ( {V}^{+} )}{( \sum SMS )} ) per Action Type$$

$${B}_{nar} = \frac{\sum {A}_{nar}}{\sum A} , where {A}_{nar} = ( \frac{( {AR}^{-} ) + 0.8 * ( {V}^{-} )}{( \sum SMS )} ) per Action Type$$

$${AR}^{+} = Automated Outgoing MIU responses$$

$${AR}^{-} = MTUDRT Outgoing by user$$

$${V}^{+} = User initiated retrieval during non \text{-} DRT$$

$${V}^{-} = User initiated DRT retrieval$$

$$\sum SMS does not equal zero$$

$$\sum SMS does not include incoming , unreceived transmissions$$

Foreseeably, the variety of Actions captured as MTUDRT require individual Bₛₘₛ and Bₙₐᵣ percentages, where the same formula is expanded to express the overall Bₛₘₛ and Bₙₐᵣ that are in essence the corporate average percentage of all action type B values over their action type counts.

The description of Bₜₛ for the user's base rating can be fixed during the grace period, substituted with the user population mean, or beyond the grace period, a formula using various percentages of time usage of the mode of texting autoresponders(AR) presently installed on the mobile technology where modes A is automatic, M+ is manual on, and M− is manual off. The sum of these percentages, as determined by AR app runtimes, should not be zero, but to ensure division remains defined, the addition of a millionth effects the 7^{th} decimal place. The base score of A and M+, k_{bts} is set at a constant similar to but less than the grace period, around 400. The k_{moff} should be 25% less than k_{bts}.

$${B}_{TS} = \{ \begin{matrix}450 ; & for 0 \leq d \leq l \\ \frac{{k}_{bts} g ( \% A + \% {M}^{+} ) + {k}_{moff} g ( \% {M}^{-} )}{( A \% + {M}^{+} \% + {M}^{-} \% + 0.000001 )} ; & for d \geq l\end{matrix} \}$$

Once B_{DI}s are calculated for relevant motion DIs, the data base associates the pre-scores with the individually contained actions, the time stamps of said actions, and any descriptive classes and/or ranks, such as GPS or speed. For each defined class a B_{DI} pre-score is calculated and assigned once. A B_{DI} score is allocated for the specific classes of all relevant DIs within a transmission data packet. More granular versions of the B_{DI}s in the scoring module can be modified to consider estimated distraction time (EDT) and keystroke/screen stroke length and frequency intervals relevant to MTUDRT.

The aggregation of B_{DI} pre-scores by definitive classes, such as speed intervals, or time periods within a day, or demographic information, etc. help to create other conditional scores and examine correlations and trends within the data. The historic DAR scores, or n-day interval MTUDRT scores since d=0 are integrated in part to create a rolling average of MTUDRT with systematic weighting of the historic scores. Distracted Driving Related Accidents (DDRA) also have a place to carry weight within a MTUDRT score, but are not to be implemented until official and formal reporting of such data is widely available. These final adjustments are primarily used to determine an overall MTUDRT score representative of up to 60 months of user data and it used to further illustrate a user's MTUDRT included in a DAR product.

The Data Instance (DI) pre-scores (B_{DI}) are not necessarily nor likely normalized. Therefore, pre-scores undergo treatment consistent with the statistical central limit theorem (CLT) to approximate a true population mean of a user's MTUDRT pre-scores under a descriptive class regardless of frequency distribution shape. This mean and standard deviation is a more accurate representation of the categorical scores than the raw mean and its standard deviation. The CLT categorical averages of BDIs are weighted by defined severity of category intervals. One bucket of all CLT treated B_{DI} is sufficient for creating a MTUDRT score, however, creating a MTUDRT speed score, for instance would create MTUDRTs for each speed interval class and then prorate the speed classes as severe based on data, such as national or state accident or death rate statistics as long as the intervals and outside data can be associated and a data source exists. Thus specializing several MTUDRT type scores are possible. Generally, any MTUDRT score within the DAR product (108) is calculated based upon the following model:

$$MIUScore = 〈 ( {k}_{HIST} ) ( \frac{\sum {MIU}_{{Hist}_{x}}}{{h}_{x}} ) + ( {k}_{DATA} ) \sum [ {k}_{{DEM}_{x}} ( \frac{\sum {B}_{{DI}_{x}}}{{n}_{x}} ) ] - {k}_{DDRA} ( \sum {n}_{DDRA} ) 〉$$

where, k (HIST) is the percentage of Historical scores applied to MTU Score, MTU (HIST_{X}) are the historical scores allowed in the calculation, h₍ₓ₎ is the number of historical scores allowed within the calculation. In addition, k_{(DATA)} is the percentage of new data applied to MTU Score, k_{(DEM(x))} are the average coefficients applied by outside statistics per class is specializing the MTUDRT, B_{DI(x)} are the actual numeric elemental CLT treated BDI scores determined to be used in the calculation within a class, and n₍ₓ₎ are the corresponding number of B_{DI} elements within each class set. K_{(DDRA)} and n_{(DDRA)} are the respective percentage and number of known Distracted Driving Related Accidents in which the member is known to be involved, whence incorporated as part of the score. The severity of DDRA types, as reporting incidents becomes more specific and externally created databases are incorporated into this invention design, will determine this information's impact on MTUDRT scores with an envisioned design of systematic roll off and point/percentages tailored to Accident count, major/minor injuries, and/or subsequent loss of life.

Methodologies and sophistication of the scoring module require individualization and specialization to tailor the DAR based upon industry relevant attributes, when said attributes are able to be captured by App/HCP and industry standards or correlating statistics exists to rate the attribute into weight intervals/buckets of B_{DI}. Utilization of the modes/options within the GUI of the App/HCP and sufficient/insufficient population of DI classes are evaluated for inclusion in MTUDRT score. Also a superior AR rating, for instance where S(AR) is defined as a superior Outgoing MTU percentage, superior V rating, for instance where S(V) is defined as a superior Incoming MTU percentage, or occasions where AR/V percentage scores fall below average or below a minimum are reserved for introduction into foreseen version of the calculation module within this present invention.

$$( \frac{\sum AR +}{{n}_{ar}} ) > S ( AR )$$

$$( \frac{\sum V +}{{n}_{v}} ) > S ( V )$$

This present invention for calculating MTUDRT scores must be allowed to include any and all unforeseen, yet relevant, advances in mobile technology itself and the subsequent user behavior. The analytical model that produces the MTU score may be further informed by additional external behavioral, demographic, or technological factors, based on subsequent research, as well as aforementioned factors to consider.

The present invented Driver Accountability Report is created through custom coding to overlay and populate a formatted structure, such as *.pdf or other, with calculated scores, corresponding graphic organizers, rating scales, data point plots, line graphs, and other inferential and descriptive data in association with the user identification information. The DAR may also be represented in an alternative embodiment in the form of a user interface via a web-portal and includes display retrieval through any number of browser-based graphical user interfaces. A delivered digital file sent to requestor/authorized applicant submitter is considered the primary delivery method via the internet of a DAR, inclusive of interpretive graphic displays and MTUDRT scores derived by mobile technology executable software, App/HCP captured data.

1. This invention claims the method of gathering data of actions and/or interactions associated to the use of Multi-function Mobile Communication Devices (MMCD) mostly comprising of what is currently known as smartphones yet inclusive of any MMCD allowing for the downloading of software applications by direct wire or wireless connection to the internet or intranet whether handheld, hands-free, or on a motor vehicle console among other options, primarily during road travel, for the creation of a Driver Accountability Report (DAR) essentially providing an assessment of the propensity of Mobile Technology Use (MTU) associated to individual drivers with a rating in the form of a score and visualizations which may be used as a gauge of distracted driving as it relates to Mobile Technology Use During Road Travel (MTUDRT). Mobile Technology Use (MTU) of MMCD for said report is gathered via executable software in the form of a mobile software application downloadable to a MMCD or as a native application to the MMCD.

2. This invention claims within the method of claim 1, the method of a mobile executable software application for the gathering of MTU of MMCD inclusive of geographic, demographic, biographical user profile, and logistical data. Software application logs compiled data into file formats and transmits via internet connection to system server.

3. This invention claims within the method of claim 1, the method of developing a score on individual drivers reflective of the propensity of MTUDRT from data gathered via mobile software applications downloadable to a MMCD or as a native application to the MMCD.
Scoring may also consider a user's profile information, historical data and research data deemed applicable to the user's demographic.

4. This invention claims within the method of claim 1, the method developing star rating comprising of a star or stars and reflective of the propensity of MTUDRT from the data gathered via mobile software applications downloadable to a MMCD or as a native application to the MMCD.

5. This invention claims within the method of claim 1, the method of categorizing MTU data as gathered via mobile software applications downloadable to a MMCD or as a native application to the MMCD for purposes of file transmissions.

6. This invention claims the System of creating a Report inclusive of MTU and MTUDRT data gathered via mobile software application(s) including the categorization of MTU data, a generated Score reflective of MTU propensity, and visualizations comprising of a star scale, risk slide scale, and Score history graphs. Report inclusion software application user population statistics, including, mean, std. deviation, and calculated t-test probabilities used to rank a user based on MTUDRT.
Definitions
DAR—Driver Accountability Report
DDRA—Distracted Driving Related Accident
MMCD—Multi-function Mobile Communication Device
MTU—Mobile Technology Use
MTUDRT—Mobile Technology Use During Road Travel
